(19) United States
(12) Patent Application Publication
(10) Pub. No.: US 2006/0289040 A1
(43) Pub. Date: Dec. 28, 2006

(54) Waterless system and method for cleaning robotic coverings

(76) Inventors: Mark D'Andreta, Ortonville, MI (US); Tommaso D'Andreta, Ortonville, MI (US)

Correspondence Address: HARNESS, DICKEY & PIERCE, P.L.C., P.O. BOX 828, BLOOMFIELD HILLS, MI, 48303, US

(21) Appl. No.: 11/159,610

(22) Filed: Jun. 23, 2005

(51) Int. Cl. B08B 7/00; B08B 3/00; B08B 7/04; B08B 9/00; C23G 1/36

(52) U.S. Cl. 134/33; 134/198; 134/166 R; 134/22.1; 134/10; 134/110

(57) ABSTRACT

A waterless system for cleaning robotic/mechanical linkage coverings, and associated method. The system can include a blower for blowing air over the robotic covering. The blower can include a fan, a blower duct, an air inlet, and an air outlet. The system can also include inlet and outlet air filters.

### INTRODUCTION

Many industrial applications, such as robotic paint facilities, for example, demand clean working environments. Robot or mechanical linkage coverings can typically be provided to keep such components clean and free of contaminants that can settle on the components, impede their function, and mar their aesthetic appeal. The coverings themselves must adhere to demanding standards regarding the amount of dust, fibers or other loose particles acceptable on the coverings. Such loose particles, if not controlled, can contaminate and ruin an otherwise flawless finishing job, as well as settle on the components that the coverings are intended to protect. Currently, existing coverings are typically cleaned by wet-washing to eliminate or reduce loose particles. Such wet-washing is less effective for plastic coverings.

Therefore, there is a need for procedures and devices that are cost- and time-efficient and can be used for coverings made from a variety of materials.

### SUMMARY

The present teachings provide a waterless method for cleaning robotic/mechanical linkage coverings. The method includes providing a blower having a duct, filtering blower incoming air, and blowing filtered air over the covering in the blower duct at a speed sufficient to substantially remove loose particles. The method can also include filtering air exiting the blower duct.

The present teachings provide a waterless system for cleaning robotic/mechanical linkage coverings. The system can include a blower for blowing air over the robotic covering. The blower can include a fan, a blower duct, an air inlet, and an air outlet. The system can also include inlet and outlet filters.

Further areas of applicability of the present invention will become apparent from the detailed description provided hereinafter. It should be understood that the detailed description and specific examples are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a plan view of a waterless system for cleaning robotic coverings according to the present teachings; and

FIG. 2 is a flowchart illustrating a waterless method for cleaning robotic coverings according to the present teachings.

### DETAILED DESCRIPTION

The following description is merely exemplary in nature and is in no way intended to limit the invention, its application, or uses. For example, although the present teachings are illustrated for robotic/mechanical linkage coverings, the present teachings can be used for any other coverings that require cleaning to remove dust and loose fibers or other particles before use.

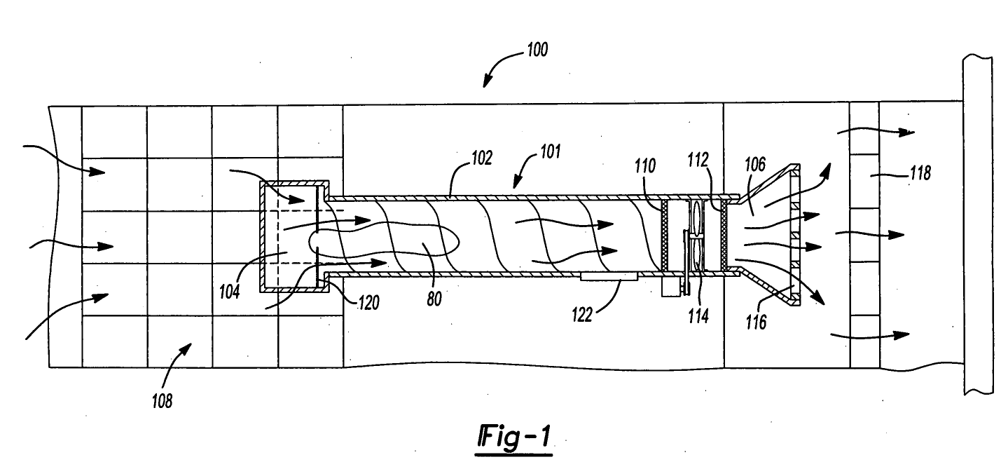

Referring to FIG. 1, an exemplary waterless system for cleaning coverings 80 according to the present teachings is generally illustrated and generally identified at reference character 100. The coverings 80 can be plastic or cloth coverings for robotic or other mechanical linkages, and generally for applications in which the number of loose fibers or other particles should be restricted, such as in paint applications of automobiles or other parts and products.

The system 100 does not require the use of water and the cleaning operation is waterless, although for cloth coverings a washing and drying procedure can also be used before the waterless procedure of the present teachings. The system 100 can include a blower 101. The blower 101 can include a blower duct 102 with an air inlet 104 for air intake, and an air outlet 106 for air exhaust. The blower duct 102 can be, for example, a spiral or other cylindrical duct. The blower 101 can also include a fan 114, which can be located by the blower duct 102 adjacent to the air outlet 106. In the exemplary illustration of FIG. 1, the fan 114 pulls air through the duct 102, and is therefore positioned downstream. The fan 114 can also be positioned in other locations that will provide sufficient air flow through the duct 102.

The fan 114 and the blower duct 102 can be designed to provide air flow of sufficient volume and speed for removing dust and other loose particles from the covering 80. The blower 101 can provide, for example, an air stream of 24,500 feet per minute at an air speed of 2500 feet per minute. The covering 80 can be held manually or by known holding devices 120, such as clips, clamps, support rods or other holding devices, at the air inlet 104. The covering 80 can be stretched along its major dimension inside the blower duct 102 by the duct's air flow, thereby presenting a large surface area for particle removal.

In the exemplary illustration of FIG. 1, the coverings 80 can be manually positioned relative to the duct 102. It will be understood, however, that the process of positioning the coverings 80 relative to the duct 102 can be automated, within the scope of the present teachings. Furthermore, it will be understood that multiple coverings 80 can be simultaneously cleaned. In one application, the coverings 80 can be placed within a basket or hopper (not shown) positioned within the duct 102. The hopper can be manually or automatically rotated to tumble the coverings 80 and thereby facilitate particle removal.

An intake filter 108 can be fitted tightly at the air inlet 104 to provide filtered air coming into the blower duct 102. The intake filter 108 can be, for example, a four-inch pleated media filter. The intake filter 108 can include one or more HEPA filters or other suitable filters. An outlet filter 118 can also be provided downstream of the fan 114 to trap particles and other debris removed from the coverings. The outlet filter 118 can include one or more HEPA or pleated media filters or other filters.

First and second protective metal screens 110, 112 can be provided upstream and downstream of the fan 114. The first and second metal screens 1 10, 112 prevent the covering from being accidentally trapped by the fan 114, and also provide user safety against injury by the fan 114. An air deflector 116, such as, for example, an appropriately perforated plate, can be positioned downstream of the outlet filter 118 for directing and dispersing air flow evenly through the area of the outlet filter 118. A trap door 122 can also be provided upstream the first metal screen 110 for providing access into the blower duct 102.

The intake air drawn into the air inlet 104 can be humidified by water or other mist or spray, and/or treated by ionization or other known methods for substantially eliminating or reducing accumulation of static electricity on the covering 80, thereby facilitating particle removal by the blower 101.

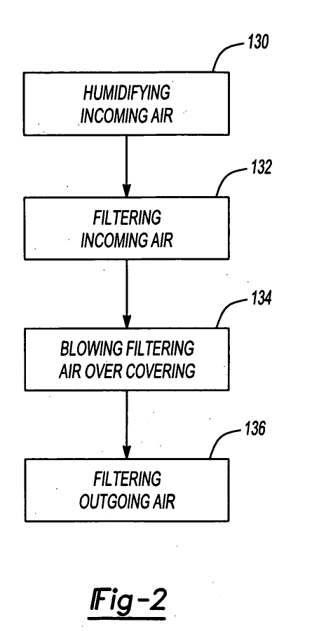

Referring to FIG. 2, a method of removing dust, fiber, and generally loose particles from coverings 80 for robotic components or other mechanical linkages is illustrated in a flowchart according to the present teachings. According to the method, incoming air can be humidified at aspect 130, and filtered at aspect 132. The humidified filtered air can be blown over the covering 80 by the fan 114 inside the blower duct 102, at aspect 134. Downstream the fan 114, the outgoing air can also be filtered prior to exhaust, at aspect 136.

It will be appreciated that although the system 100 and associated method can be particularly suitable for plastic coverings, the system 100 and associated method can also be used for cloth coverings, substituting or supplementing washing or other wet-cleaning procedures. Nevertheless, the waterless system 100 avoids the inefficiencies associated with wet laundering and drying, such as having to provide clean water and dispose contaminated water. Moreover, the waterless cleaning method is faster, cost-efficient and more effective.

The foregoing discussion discloses and describes merely exemplary arrangements of the present invention. One skilled in the art will readily recognize from such discussion, and from the accompanying drawings and claims, that various changes, modifications and variations can be made therein without departing from the spirit and scope of the invention as defined in the following claims.

What is claimed is:

1. A waterless method for removing particles from a robotic/mechanical linkage covering, the method comprising:
providing a blower having a duct;
filtering incoming air; and
blowing filtered air over the covering in the blower duct at a speed sufficient to substantially remove the particles.

2. The method of claim 1, further comprising filtering the air exiting the blower duct.

3. The method of claim 2, further comprising humidifying blower incoming air.

4. The method of claim 3, wherein humidifying comprises misting incoming air.

5. The method of claim 2, further comprising controlling static electricity of blower incoming air.

6. The method of claim 2, further comprising discharging static electricity from the covering.

7. The method of claim 6, wherein discharging static electricity comprises directing ionized air over the covering.

8. A waterless system for cleaning robotic/mechanical linkage coverings, the system comprising:
a blower having a fan, a blower duct, an air inlet, and an air outlet, the blower operable for blowing air over the robotic covering; and
an inlet filter at the air inlet for filtering incoming air.

9. The system of claim 8, further comprising an outlet filter at the air outlet for filtering outgoing air.

10. The system of claim 9, wherein the blower duct comprises a trap door.

11. The system of claim 9, wherein each the inlet and outlet filters comprise at least one pleated media filter.

12. The system of claim 9, further comprising an air deflector upstream of the outlet filter.

13. The system of claim 12, wherein the air deflector comprises a perforated plate.

14. The system of claim 12, further comprising a metal screen between the fan and the air deflector.

15. The system of claim 14, further comprising a metal screen upstream of the fan.
